(19) United States
(12) Patent Application Publication
(10) Pub. No.: US 2020/0045961 A1
(43) Pub. Date: Feb. 13, 2020

(54) HERBICIDAL MIXTURE FOR USE ON WEEDS

(71) Applicant: Adama Agan Ltd., Ashdod (IL)

(72) Inventors: Narahari PULLAIAH, Secunderabad (IN); Srinivasan RENGAN, Secunderabad (IN)

(73) Assignee: Adama Agan Ltd., Ashdod (IL)

(21) Appl. No.: 16/485,834

(22) PCT Filed: Feb. 14, 2018
(86) PCT No.: PCT/IL2018/050172

§ 371 Date: Aug. 14, 2019

(30) Foreign Application Priority Data
Feb. 16, 2017 (IN) 201741005580

(51) Int. Cl. A01N 41/06; A01N 43/60

(52) U.S. Cl. CPC A01N 41/06; A01N 43/60

(57) ABSTRACT

The present subject matter relates to method of controlling undesired vegetation by applying a herbicidally effective amount of fomesafen and propaquizafop to a locus of the undesired vegetation.

### TECHNICAL FIELD

The present subject matter relates to a herbicidal mixture for controlling undesired vegetation.

### BACKGROUND

The control of undesired vegetation is extremely important in order to achieve high crop efficiency. In many cases, while herbicides have an effect against a spectrum of weeds, they do not however fight a certain type of other weeds, which is also present in the crop cultures to be protected. Therefore, there is a strong need for mixing two or more herbicides.

Mixtures of selected herbicides have several advantages over the use of a single herbicide including (a) an increase in the spectrum of weeds controlled or an extension of weed control over a longer period of time, (b) an improvement in crop safety by using minimum doses of selected herbicides applied in combination rather than a single high dose of one herbicide, and (c) a delay in the appearance of resistant weed species to selected herbicides (Int. J. Agri. Biol., Vol. 6, No. 1, 2004, pages 209-212).

However, the activity and selectivity behavior of any specific mixture is difficult to predict since the behavior of each single herbicide in the mixture is often affected by the presence of the other(s) and the activity of the mixture may also vary considerably depending on chemical character, plant species, growth stage, and environmental conditions. Mostly, this practice results in reduced activity of the herbicides in the mixture.

Fomesafen 5-[2-chloro-4-(trifluoromethyl)phenoxy]-N-(methylsulfonyl)-2-nitrobenzamide was first reported by S. R. Colby et al. (Proc. Int. Congr. Plant Prot., 10th, 1983, 1, 295). Fomesafen is a protoporphyrinogen oxidase inhibitor. It is a selective herbicide which is absorbed by both leaves and roots, with very limited translocation in the phloem. Fomesafen is used as a post-emergence control of broad-leaved weeds soya beans.

Propaquizafop (R)-2-[[(1-methylethylidene)amino]oxy]ethyl 2-[4-[(6-chloro-2-quinoxalinyl)oxy]phenoxy]propanoate was first reported by P. F. Bocion et al. (Proc. 1987 Br. Crop Prot. Conf.—Weeds, 1, 55). Propaquizafop is a fatty acid synthesis inhibitor, and acts by the inhibition of acetyl CoA carboxylase (ACCase). It is a systemic post-emergence herbicide which is absorbed by the foliage and the roots, and translocated through the plant. Propaquizafop is used to control of a wide range of annual and perennial grasses in soya beans, cotton, sugar beet, potatoes, peanuts, peas, oilseed rape and vegetables. (e-Pesticide Manual V5.2 ISBN 978 1 901396 85 0).

The herbicidal combination of fomesafen and propaquizafop provides a wide-spectrum coverage of grasses and broad-leaved weeds.

### SUMMARY

According to one aspect, the present subject matter provides a herbicidal mixture comprising fomesafen and propaquizafop. According to some embodiments, the mixture provides a synergistic effect.

According to another aspect, the present subject matter provides a herbicidal composition for the selective control of weeds and grasses in crops of cultivated plants comprising fomesafen and propaquizafop. The composition may further comprise at least one agriculturally acceptable carrier. According to some embodiments, the composition may further comprise at least one surfactant, solid diluent, liquid diluent, or a combination thereof. According to other embodiments, the composition provides a synergistic effect.

According to another aspect, the present subject matter provides a method of controlling undesired vegetation comprising applying to a locus of the undesired vegetation a herbicidally effective amount of a herbicidal combination of fomesafen and propaquizafop. The combination may be applied in a synergistically effective amount. According to some embodiments, the undesired vegetation is selected from the group comprising monocotyledonous weed and dicotyledonous weed.

### DETAILED DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the phrase “agriculturally acceptable carrier” means carriers which are known and accepted in the art for the formation of formulations for agricultural or horticultural use.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. In yet another embodiment, the term “plant” may include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” includes not only areas where weeds may already be growing, but also areas where weeds have yet to emerge, and also to areas under cultivation.

As used herein, the term “post-emergence,” refers to the application of the herbicidal combination to the weeds that have emerged from the soil. The term “pre-emergence” refers to the application of the herbicidal combination to a habitat, a weed, or soil, prior to the emergence of the weeds from the soil.

As used herein, the term “control of undesirable vegetation” refers to the interference with the normal growth and development of undesired vegetation. Examples of control activity include, but are not limited to, inhibition of root growth, inhibition of shoot growth, inhibition of shoot emergence, inhibition of seed production, or reduction of weed biomass.

As used herein, the term “effective amount” refers to an amount of the compound that, when ingested, contacted with or sensed, is sufficient to achieve a good level of control.

As used herein, the term “mixture” or “combination” refers, but is not limited to, a combination in any physical form, e.g., blend, solution, alloy, or the like.

The term “a” or “an” as used herein includes the singular and the plural, unless specifically stated otherwise. Therefore, the terms “a,” “an” or “at least one” can be used interchangeably in this application.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

Throughout the application, descriptions of various embodiments use the term “comprising”; however, it will be understood by one of skill in the art, that in some specific instances, an embodiment can alternatively be described using the language “consisting essentially of” or “consisting of.”

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

### Herbicidal Mixture

It has been found that the combination of fomesafen and propaquizafop results in improved herbicidal activity against undesired vegetation. In some embodiments, the combination provides a higher herbicidal activity than that envisaged on the basis of the sum of activities of each of the herbicides found therein. Such a combination allows the reduced dosages of the individual herbicides which can damage agriculturally important plants.

The present subject matter relates to a herbicidal mixture of fomesafen and propaquizafop.

The present subject matter further relates to a composition for the selective control of weeds and grasses in crops of cultivated plants comprising fomesafen and propaquizafop. In an embodiment, the composition further comprises an agriculturally acceptable carrier.

The weight ratio of the fomesafen to propaquizafop cannot generally be defined, as it varies depending upon various conditions such as the type of the formulation, weather conditions, the type of crop and the type of weeds.

In one embodiment, the weight ratio of fomesafen to propaquizafop in the mixture is from about 1:1000 to 1000:1. In another embodiment, the weight ratio of fomesafen to propaquizafop is from about 1:100 to 100:1. In yet another embodiment, the weight ratio of fomesafen to propaquizafop is from about 1:10 to 10:1. In an embodiment, the weight ratio of fomesafen to propaquizafop is from about 1:2 to 2:1. In a further embodiment, the weight ratio of fomesafen to propaquizafop is about 1:1.

The weight ratio of fomesafen to propaquizafop may be an intermediate range selected from the above indicated ratios.

In an embodiment, the weight ratio of fomesafen to propaquizafop is 1:50 and/or above this ratio. In an embodiment, the weight ratio of fomesafen to propaquizafop is 1:5 and/or above this ratio. In an embodiment, the weight ratio of fomesafen to propaquizafop is 1:4 and/or above this ratio. In an embodiment, the weight ratio of fomesafen to propaquizafop is 1:3 and/or above this ratio. In an embodiment, the weight ratio of fomesafen to propaquizafop is 1:2 and/or above this ratio. In an embodiment, the weight ratio of fomesafen to propaquizafop is 1:1.5 and/or above this ratio. In an embodiment, the weight ratio of fomesafen to propaquizafop is 1:1 and/or above this ratio. In an embodiment, the weight ratio of fomesafen to propaquizafop is 1:0.75 and/or above this ratio. In an embodiment, the weight ratio of fomesafen to propaquizafop is 1:0.5 and/or above this ratio. In an embodiment, the weight ratio of fomesafen to propaquizafop is 1:0.25 and/or above this ratio. In an embodiment, the weight ratio of fomesafen to propaquizafop is 1.25:1 and/or above this ratio. In an embodiment, the weight ratio of fomesafen to propaquizafop is 1.5:1 and/or above this ratio. In an embodiment, the weight ratio of fomesafen to propaquizafop is 1.75:1 and/or below this ratio. In an embodiment, the weight ratio of fomesafen to propaquizafop is 2:1 and/or below this ratio. In an embodiment, the weight ratio of fomesafen to propaquizafop is 2.25:1 and/or below this ratio. In an embodiment, the weight ratio of fomesafen to propaquizafop is 3:1 and/or below this ratio. In an embodiment, the weight ratio of fomesafen to propaquizafop is 5:1 and/or below this ratio. In an embodiment, the weight ratio of fomesafen to propaquizafop is 10:1 and/or below this ratio. In an embodiment, the weight ratio of fomesafen to propaquizafop is 50:1 and/or below this ratio.

The weight ratio of the weight ratio of fomesafen to propaquizafop may be an intermediate range selected from the above indicated ratios.

Additionally, the present subject matter provides a method of controlling undesired vegetation comprising applying to a locus of the undesired vegetation a synergistically effective amount of a herbicidal combination of fomesafen and propaquizafop.

The herbicidally effective application rates of fomesafen and propaquizafop cannot generally be defined, as it varies depending upon various conditions such as the type of the formulation, weather conditions, the type of crop and the type of weeds.

In an embodiment, the herbicidal mixture may be applied to the locus of undesired vegetation in an amount of from about 1 to 5000 g/ha. In a further embodiment, the herbicidal mixture may be applied in an amount of from about 1 to 1000 g/ha. In yet another embodiment, the herbicidal mixture may be applied in an amount of from about 1 to 500 g/ha. In yet another embodiment, the application rates of the herbicidal mixture are from about 1 g/ha to 300 g/ha. In yet another embodiment, the application rates of the herbicidal mixture are from about 1 g/ha to 250 g/ha. In yet another embodiment, the application rates of the herbicidal mixture are from about 1 g/ha to 200 g/ha. In yet another embodiment, the application rates of the herbicidal mixture are from about 1 g/ha to 150 g/ha. In yet another embodiment, the application rates of the herbicidal mixture are from about 1 g/ha to 100 g/ha. In yet another embodiment, the application rates of the herbicidal mixture are from about 1 g/ha to 50 g/ha. The above ranges refer to the application rates of a combination of fomesafen and propaquizafop (namely a sum of the application rate of both active ingredients).

In a specific embodiment, the application rate of the application rates of the herbicidal mixture are from about is selected from 1 g/ha and above, 2 g/ha and above, 4 g/ha and above, 5 g/ha and above, 10 g/ha and above, 20 g/ha and above, 30 g/ha and above, 40 g/ha and above, 50 g/ha and above, 60 g/ha and above, 70 g/ha and above, 80 g/ha and above, 90 g/ha and above, 100 g/ha and above.

In a specific embodiment the application rate of the application rates of the herbicidal mixture are from about are selected from 1000 g/ha and below, 500 g/ha and below, 300 g/ha and below, 250 g/ha and below, 200 g/ha and below, 150 g/ha and below, 100 g/ha and below, 50 g/ha and below.

The above ranges refer to the application rates of a combination of fomesafen and propaquizafop (namely a sum of the application rate of both active ingredients).

As used in the present methods, the herbicidal compositions and herbicidal mixtures discussed herein may be applied jointly or in a succession. That is, each of fomesafen and propaquizafop may be applied jointly or in succession. In one example, fomesafen and propaquizafop are prepared separately, and the individual formulations are applied as is, or diluted to predetermined concentrations. In a further example, fomesafen and propaquizafop are prepared separately, and the formulations are mixed when diluted to a predetermined concentration. In another example, fomesafen and propaquizafop are formulated together, and the formulation is applied as it is, or the formulation is diluted to a predetermined concentration. According to an embodiment, a herbicidal composition comprising a synergistic effective amount of a herbicidal combination of fomesafen and propaquizafop for use in controlling undesired vegetation, is provided.

According to an embodiment, the composition comprises at least one additional component selected from the group of surfactants, solid diluents and liquid diluents.

The present composition can be made at the time of use, or diluted. The present compositions can also be concentrated compositions, or so-called “ready-to-use” compositions, that is to say, compositions ready for use. Alternatively, the present compositions may be applied in a combined spray mixture composed from separate formulations of the single active ingredients, such as a “tank-mix” form.

In yet another embodiment, the herbicidal composition may be applied in the form of a ready-for-use formulation comprising fomesafen and propaquizafop. This formulation can be obtained by combining fomesafen and propaquizafop in a herbicidally effective amount with an agriculturally acceptable carrier, a surfactant or other application-promoting adjuvant customarily employed in formulation technology.

The present composition may be employed or prepared in any conventional form, for example, in the form of a twin pack, or for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, solvent or oil, which are suitable for dilution with water.

In an embodiment, the combined amount of fomesafen and propaquizafop in the composition is about 0.1-99 wt. %, about 0.1-95 wt. %, or about 0.1-90 wt. %, based on the total weight of the composition. In another embodiment, the combined amount of fomesafen and propaquizafop in the composition is about is about 1-70 wt. %, based on the total weight of the composition. In yet another embodiment, the combined amount of fomesafen and propaquizafop in the composition is about is about 1-50 wt. %, based on the total weight of the composition. In yet another embodiment, the combined amount of fomesafen and propaquizafop in the composition is about is about 1-40 wt. %, based on the total weight of the composition. In yet another embodiment, the combined amount of fomesafen and propaquizafop in the composition is about is about 1-30 wt. %, based on the total weight of the composition. In yet another embodiment, the combined amount of fomesafen and propaquizafop in the composition is about is about 1-20 wt. %, based on the total weight of the composition. In yet another embodiment, the combined amount of fomesafen and propaquizafop in the composition is about is about 1-10 wt. %, based on the total weight of the composition. The remaining components in the formulation are for example the carrier and additives.

In yet another embodiment, the amount of the mixture of active ingredients in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition. The present composition may include additional crop protection agents, for example for example insecticides, herbicides, fungicides, bactericides, nematicides, molluscicides, growth regulators, biological agents, fertilizers, or mixtures thereof. However, for the avoidance of doubt it is understood that such additional crop protection agents are unnecessary to achieve the desired control of undesired vegetation as achieved by the present combinations. Accordingly, the present herbicidal compositions and herbicidal mixtures may be limited to containing fomesafen and propaquizafop, as the only crop protection agents and/or herbicides present.

Without departing from the scope of the subject matter, the mixture and formulations of the present subject matter may be applied in conjunction with one or more co-herbicides to control a wider variety of undesirable vegetation. When used in conjunction with co-herbicides, the composition can be formulated with the co-herbicide or co-herbicides, tank mixed with the co-herbicide or co-herbicides or applied sequentially with the co-herbicide or co-herbicides. Some of the co-herbicides that can be employed in conjunction with the mixture of the present subject matter include but are not limited to 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isoctyl, 2,4-D-isopropyl, 2,4-D-isopropylammonium, 2,4-D-sodium, 2,4-D-isopropanolammonium, 2,4-D-trolamine, 2,4-DB, 2,4-DB-butyl, 2,4-DB-dimethylammonium, 2,4-DB-isoctyl, 2,4-DB-potassium, 2,4-DB-sodium, dichlorprop, dichlorprop-butotyl, dichlorprop-dimethylammonium, dichlorprop-isoctyl, dichlorprop-potassium, dichlorprop-P, dichlorprop-P-dimethylammonium, dichlorprop-P-potassium, dichlorprop-P-sodium, MCPA, MCPA-butotyl, MCPA-dimethylammonium, MCPA-2-ethylhexyl, MCPA-potassium, MCPA-sodium, MCPA-thioethyl, MCPB, MCPB-ethyl, MCPB-sodium, mecoprop, mecoprop-butotyl, mecoprop-sodium, mecoprop-P, mecoprop-P-butotyl, mecoprop-P-dimethylammonium, mecoprop-P-2-ethylhexyl, mecoprop-P-potassium, naproanilide, clomeprop, 2,3,6-TBA, dicamba, dicamba-butotyl, dicamba-diglycolamine, dicamba-dimethylammonium, dicamba-diolamine, dicamba-isopropylammonium, dicamba-potassium, dicamba-sodium, dichlobenil, picloram, picloram-dimethylammonium, picloram-isoctyl, picloram-potassium, picloram-triisopropanolammonium, picloram-triisopropylammonium, picloram-trolamine, triclopyr, triclopyr-butotyl, triclopyr-triethylammonium, clopyralid, clopyralid-olamine, clopyralid-potassium, clopyralid-triisopropanolammonium, aminopyralid, naptalam, naptalam-sodium, benazolin, benazolin-ethyl, quinclorac, quinmerac, diflufenzopyr, diflufenzopyr-sodium, fluroxypyr, fluroxypyr-2-butoxy-1-methylethyl, fluroxypyr-meptyl, chlorflurenol, chlorflurenol-methyl, aminocyclopyrachlor, aminocyclopyrachlor-methyl, aminocyclopyrachlor-potassium, chlorotoluron, diuron, fluometuron, linuron, isoproturon, metobenzuron, tebuthiuron, dimefuron, isouron, karbutilate, methabenzthiazuron, metoxuron, monolinuron, neburon, siduron, terbumeton, trietazine, metobromuron, simazine, atrazine, atratone, simetryn, prometryn, dimethametryn, hexazinone, metribuzin, teroutnyiazine, cyanazine, ametryn, cybutryne, triaziflam, indaziflam, terbutryn, propazine, metamitron, prometon, bromacil, bromacyl-lithium, lenacil, terbacil, propanil, cypromid, swep, desmedipham, phenmedipham, bromoxynil, bromoxynil-octanoate, bromoxynil-heptanoate, ioxynil, ioxynil-octanoate, ioxynil-potassium, ioxynil-sodium, pyridate, bentazone, bentazone-sodium, amicarbazone, methazole, pentanochlor, paraquat, diquat, nitrofen, chlomethoxyfen, bifenox, acifluorfen, acifluorfen-sodium, fomesafen-sodium, oxyfluorfen, lactofen, aclonifen, ethoxyfen-ethyl (HC-252), fluoroglycofen-ethyl, fluoroglycofen, chlorphthalim, flumioxazin, flumiclorac, flumiclorac-pentyl, cinidon-ethyl, fluthiacet, fluthiacet-methyl, oxadiargyl, oxadiazon, sulfentrazone, carfentrazone-ethyl, thidiazimin, pentoxazone, azafenidin, isopropazole, pyraflufen-ethyl, benzfendizone, butafenacil, saflufenacil, flupoxam, fluazolate, profluazol, pyraclonil, flufenpyr-ethyl, bencarbazone, ethyl[3-(2-chloro-4-fluoro-5-(3-methyl-2,6-dioxo-4-trifluoromethyl-3,6-dihydro-2H-pyrimidin-1-yl)phenoxy)pyridin-2-yloxy]acetate (SYN-523), norflurazon, chloridazon, metflurazon, pyrazolynate, pyrazoxyfen, benzofenap, topramezone, pyrasulfotole, amitrole, fluridone, flurtamone, diflufenican, methoxyphenone, clomazone, sulcotrione, mesotrione, tembotrione, tefuryltrione, bicyclopyrone, isoxaflutole, difenzoquat, difenzoquat-metilsulfate, isoxachlortole, benzobicyclon, picolinafen, beflubutamid, diclotop-methyl, diclotop, pyriphenop-sodium, fluazifop-butyl, fluazifop, fluazifop-P, fluazifop-P-butyl, haloxyfop-methyl, haloxyfop, haloxyfop-etotyl, haloxyfop-P, haloxyfop-P-methyl, quizalofop-ethyl, quizalofop-P, quizalofop-P-ethyl, quizalofop-P-tefuryl, cyhalofop-butyl, fenoxaprop-ethyl, fenoxaprop-P, fenoxaprop-P-ethyl, metamifop-propyl, metamifop, clodinafop-propargyl, clodinafop, alloxydim-sodium, alloxydim, clethodim, sethoxydim, tralkoxydim, butroxydim, tepraloxydim, profoxydim, cycloxydim, flamprop-M-methyl, flamprop-M, flamprop-M-isopropyl, chlorimuron-ethyl, chlorimuron, sulfometuron-methyl, sulfometuron, primisulfuron-methyl, primisulfuron, bensulfuron-methyl, bensulfuron, chlorsulfuron, metsulfuron-methyl, metsulfuron, cinosulfuron, pyrazosulfuron-ethyl, pyrazosulfuron, azimsulfuron, rimsulfuron, imazosulfuron, cyclosulfamuron, prosulfuron, flupyrsulfuron-methyl-sodium, flupyrsulfuron, triflusulfuron-methyl, triflusulfuron, halosulfuron-methyl, halosulfuron, thifensulfuron-methyl, thifensulfuron, ethoxysulfuron, oxasulfuron, ethametsulfuron, ethametsulfuron-methyl, iodosulfuron, iodosulfuron-methyl-sodium, sulfosulfuron, triasulfuron, tribenuron-methyl, tribenuron, tritosulfuron, foramsulfuron, trifloxysulfuron, trifloxysulfuron-sodium, mesosulfuron, mesosulfuron-methyl, orthosulfamuron, flucetosulfuron, amidosulfuron, propyrisulfuron, metazosulfuron, iofensulfuron, flumetsulam, metosulam, diclosulam, cloransulam-methyl, florasulam, penoxsulam, pyroxsulam, imazapyr, imazapyr-isopropylammonium, imazethapyr, imazethapyr-ammonium, imazaquin, imazaquin-ammonium, imazamox, imazamox-ammonium, imazamethabenz, imazamethabenz-methyl, imazapic, pyrithiobac-sodium, bispyribac-sodium, pyriminobac-methyl, pyribenzoxim, pyriftalid, pyrimisulfan, triafamone, flucarbazone, flucarbazone-sodium, propoxycarbazone-sodium, propoxycarbazone or thiencarbazone, glyphosate, glyphosate-sodium, glyphosate-potassium, glyphosate-ammonium, glyphosate-diammonium, glyphosate-isopropylammonium, glyphosate-trimesium, glyphosate-sesquisodium, glufosinate, glufosinate-ammonium, glufosinate-P, glufosinate-P-ammonium, glufosinate-P-sodium, bilanafos, bilanafos-sodium, cinmethylin, trifluralin, oryzalin, nitralin, pendimethalin, ethalfluralin, benfluralin, prodiamine, butralin, dinitramine, bensulide, napropamide, propyzamide, pronamide, amiprofos-methyl, butamifos, anilofos, piperophos, propham, chlorpropham, barban, carbetamide, daimuron, cumyluron, bromobutide, methyldymron, asulam, asulam-sodium, dithiopyr, thiazopyr, chlorthal-dimethyl, chlorthal, diphenamid, alachlor, metazachlor, butachlor, pretilachlor, metolachlor, thenylchlor, pethoxamid, acetochlor, propachlor, dimethenamid, dimethenamid-P, propisochlor, dimethachlor, molinate, dimepiperate, pyributicarb, EPTC, butylate, vernolate, pebulate, cycloate, prosulfocarb, esprocarb, thiobencarb, triallate, diallate, orbencarb, etobenzanid, mefenacet, flufenacet, tridiphane, cafenstrole, fentrazamide, oxaziclomefone, indanofan, benfuresate, pyroxasulfone, fenoxasulfone, dalapon, dalapon-sodium, TCA-sodium, trichloroacetic acid, MSMA, DSMA, CMA, endothall, endothall-dipotassium, endothall-sodium, endothall-mono(N,N-dimethylalkylammonium), ethofumesate, sodium chlorate, pelargonic acid (nonanoic acid), fosamine, fosamine-ammonium, pinoxaden, ipfencarbazone, aclolein, ammonium sulfamate, borax, chloroacetic acid, sodium chloroacete, cyanamide, methylarsonic acid, dimethylarsinic acid, sodium dimethylarsinate, dinoterb, dinoterb-ammonium, dinoterb-diolamine, dinoterb-acetate, DNOC, ferrous sulfate, flupropanate, flupropanate-sodium, isoxaben, mefluidide, mefluidide-diolamine, metam, metam-ammonium, metam-potassium, metam-sodium, methyl isothiocyanate, pentachlorophenol and sodium pentachlorophenoxide.

In a specific embodiment, the present subject matter relates to a method of controlling undesired vegetation comprising applying to a locus of the undesired vegetation a synergistically effective amount of a herbicidal combination of fomesafen and propaquizafop.

The herbicidal mixture may be applied to undesired vegetation or may be applied to the locus of the undesired vegetation. Further, it may be applied pre-post emergence, post-emergence or early-post-emergence. In certain embodiments, the mixture may be applied pre-emergence and post-emergence to the locus of the undesired vegetation. The herbicidal mixture may be applied via foliar application, basal application, soil application, soil incorporation or soil injection.

In an embodiment, the mixture is applied on crops which include one or more of soybeans, beans, blackgram, greengram, peanuts, leguminous crops, cotton, and fruit and vegetable crops. That is, the locus of undesired vegetation may contain one or more of these crops.

In a further embodiment, the mixture is applied in non-crop areas which include but are not limited to, turfgrass, pastures, grasslands, rangelands, fallow land, rights-of-way, golf courses, parks, along roadsides, power-lines, pipelines, rights-of-way, railways and forests. well sites, and equipment yards.

In one embodiment, the undesired vegetation may be monocotyledonous weeds or dicotyledonous weeds, for example, Echinochloa Colona, Echinochloa crusgalli, Bracharia sp., Digitaria sp., Dactylactenium sp., Setaria sp., Panicum sp., Pennisetum sp., Rotboellia sp., Saccharum sp., Dinebra Arabica, Cynotis sp., Eleusine Indica, Cynodon Dactylon, Euphorbia Hirta, Digeria Arvensis, Digera sp., Phyllanthus sp., Commelina benghalensis, Parthenium sp., Trianthema Portulacastrum, Cleome viscosa, Digera arvensis, Parthenium hysterophorus, Cynadon dactylon, Commelina sinensis, Dinebra sp., Portulaca sp., Trianthema sp., Dactyloctenium aegyptium, Corchorus sp., Trianthema monogyna, Alternanthera sp., Lactuca sp., Euphorbia geniculate, Acalypha indica, Ipomeas sp., Amaranthus viridis, Celosia argentea, Xanthium strumarium, Physalis minima, Phyllanthus niruri, Cyanotis sp., Alternanthera triandra, and Cyprus rotundus.

In another embodiment, a kit is provided, comprising a herbicidal composition of fomesafen and propaquizafop as described herein, or components thereof. Such kits may comprise, in addition to the aforementioned active components, one or more additional active and/or inactive ingredients, either within the provided herbicidal composition or separately. Certain kits comprise fomesafen and propaquizafop, each in a separate container, and each optionally combined with a carrier.

As noted above, the herbicidal compositions, kits and methods described herein may exhibit a synergistic effect. The herbicidal compositions, kits and methods described herein can broaden the spectrum of control, and/or minimize the dosages of fomesafen and propaquizafop being used when compared to the use of such individual pesticides alone.

The instructions may be in the form of printed matter, for example either as inserts or labels.

A synergistic effect exists wherever the action of a combination of active ingredients is greater than the sum of the action of each of the components alone. Therefore, a synergistically effective amount (or an effective amount of a synergistic composition or combination) as discussed herein is an amount that exhibits greater herbicidal activity than the sum of the herbicidal activities of the individual components.

Comparison of results between formulations, mixtures and individual herbicides may be accomplished by a number of different methods. The synergy of the mixture or formulation may be calculated, the % survival of the weeds may be determined, % efficacy of the herbicide may be determined and the amount of biomass of the weeds may be determined, visually or otherwise. It may be appreciated that biomass may be defined as the organic material present on the weeds. In some embodiments, the application of herbicides may diminish the biomass of weeds. This may be done by preventing the weed to grow beyond a certain point and/or prevent the weed from developing seeds and/or leaves and/or branches and/or other parts of the plant.

In the context of the present subject matter, the term “synergy” is as defined by Colby S. R. in an article entitled “Calculation of the synergistic and antagonistic responses of herbicide combinations” published in the journal Weeds, 1967, 15, p. 20-22, incorporated herein by reference in its entirety. The action expected for a given combination of three active ingredients can be calculated as follows:

$$E = X + Y - \frac{XY}{100}$$

in which E represents the expected percentage of herbicidal control for the combination of the three herbicides at defined doses (for example equal to x, y and z respectively), X is the percentage of herbicidal control observed by fomesafen at a defined dose (equal to x), Y is the percentage of herbicidal control observed by propaquizafop at a defined dose (equal to y). When the percentage of herbicidal control observed for the combination is greater than the expected percentage, there is a synergistic effect. When the percentage of control observed for the combination is equal to the expected percentage, there is an additive effect and wherein the percentage of herbicidal control observed for the combination is lower than the expected percentage, there is an antagonistic effect.

### EXPERIMENTAL DETAILS

The experiments were conducted by applying fomesafen and commercially available Agil (propaquizafop 10% EC, 100 gr/L) alone or together at different concentrations. The herbicides were applied to grassy and broad-leaved weeds in a crop of soybeans using different application rates.

The herbicides were applied using the following applications rates:

| | Treatments | Rate (gai/ha) | Rate (ml/ha) |
|---|---|---|---|
| 1 | Untreated Control | 0 | 0 |
| 2 | Propaquizafop 100 EC (10%) | 40 | 400 |
| 3 | Propaquizafop 100 EC (10%) | 50 | 500 |
| 4 | Fomesafen 25% SL | 125 | 500 |
| 5 | Fomesafen 25% SL | 187.5 | 750 |
| 6 | Fomesafen 25% SL | 250 | 1000 |
| 7 | Propaquizafop 100 EC (10%) + | 40 + 125 | 400 + 500 |
| | Fomesafen 25% SL | | |
| 8 | Propaquizafop 100 EC (10%) + | 50 + 125 | 500 + 500 |
| | Fomesafen 25% SL | | |
| 9 | Propaquizafop 100 EC (10%) + | 40 + 187.5 | 400 + 750 |
| | Fomesafen 25% SL | | |
| 10 | Propaquizafop 100 EC (10%) + | 50 + 187.5 | 500 + 750 |
| | Fomesafen 25% SL | | |
| 11 | Propaquizafop 100 EC (10%) + | 40 + 250 | 400 + 1000 |
| | Fomesafen 25% SL | | |
| 12 | Propaquizafop 100 EC (10%) + | 50 + 250 | 500 + 1000 |
| | Fomesafen 25% SL | | |

*2 g/L of ammonium sulfate was added to all mixtures of propaquizafop and fomesafen.

Applications were made with a Knapsack sprayer fitted with Flat fan nozzle for the application of herbicides. Experiment design was in random blocks with three replication and nine treatments.

The trials of examples 1-7 were conducted on Soybean crop in the district of Sehore (India). The sowing was done during the last week of June with a soybean variety JS9560. The applications were applied 20 DAS. Design & Plot size: RBD & 25 Sq.mt.

Species wise weed count may be recorded at 15, 30 and 45 DAA (Days After Application). A subjective score of damage done by the herbicide on the plants may be given based on the weed count compared to the untreated checks. A score of 100% indicated complete control and a score of 0% indicates zero herbicide effect.

The % control observed may be calculated as follows:

$$\% control observed = \frac{\begin{matrix}Mean weed count in untreated control - \\ Mean weed count in treated plot\end{matrix}}{Mean weed count in untreated control} * 100$$

The synergy of the mixture of fomesafen and propaquizafop may be calculated using the formula:

$$E = X + Y - \frac{XY}{100}$$

which is described hereinabove.

### Example 1: Effect of Tank Mix of Fomesafen+Propaquizafop on Echinochloa colona

TABLE 1
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 72.9 | 70.8 | 70.4 | | | | | | |
| Propaquizafop | 500 | 75.8 | 73.9 | 72.9 | | | | | | |
| Fomesafen | 500 | 8.91 | 6.65 | 5.02 | | | | | | |
| Fomesafen | 750 | 14 | 10.7 | 7.5 | | | | | | |
| Fomesafen | 1000 | 18.2 | 15.8 | 13.6 | | | | | | |
| Propaquizafop + | 400 + 500 | 93.4 | 92.1 | 91 | 75.3 | 72.8 | 71.9 | 1.24 | 1.27 | 1.27 |
| Fomesafen | | | | | | | | | | |
| Propaquizafop + | 500 + 500 | 94.2 | 92 | 91.5 | 78 | 75.6 | 74.3 | 1.21 | 1.22 | 1.23 |
| Fomesafen | | | | | | | | | | |
| Propaquizafop + | 400 + 750 | 95.3 | 93.4 | 92.6 | 76.7 | 74 | 72.6 | 1.24 | 1.26 | 1.28 |
| Fomesafen | | | | | | | | | | |
| Propaquizafop + | 500 + 750 | 96.1 | 94.1 | 93.7 | 79.2 | 76.7 | 75 | 1.21 | 1.23 | 1.25 |
| Fomesafen | | | | | | | | | | |
| Propaquizafop + | 400 + 1000 | 97.8 | 95.9 | 94.8 | 77.8 | 75.5 | 74.5 | 1.26 | 1.27 | 1.27 |
| Fomesafen | | | | | | | | | | |
| Propaquizafop + | 500 + 1000 | 98.8 | 96.3 | 95.5 | 80.2 | 78 | 76.6 | 1.23 | 1.23 | 1.25 |
| Fomesafen | | | | | | | | | | |

### Example 2: Effect of Tank Mix of Fomesafen+Propaquizafop on Dinebra arabica

TABLE 2
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 68.2 | 67 | 65 | | | | | | |
| Propaquizafop | 500 | 72.3 | 69.1 | 66 | | | | | | |
| Fomesafen | 500 | 2.62 | 1.33 | 0.21 | | | | | | |
| Fomesafen | 750 | 15.2 | 11.1 | 10 | | | | | | |
| Fomesafen | 1000 | 23.4 | 16.4 | 14.3 | | | | | | |
| Propaquizafop + | 400 + 500 | 87.4 | 86.8 | 84.8 | 69 | 67.5 | 65.1 | 1.27 | 1.29 | 1.3 |
| Fomesafen | | | | | | | | | | |
| Propaquizafop + | 500 + 500 | 90.5 | 88.5 | 85.8 | 73 | 69.5 | 66 | 1.24 | 1.27 | 1.3 |
| Fomesafen | | | | | | | | | | |
| Propaquizafop + | 400 + 750 | 92.7 | 90.2 | 88.1 | 73 | 70.7 | 68.5 | 1.27 | 1.28 | 1.29 |
| Fomesafen | | | | | | | | | | |
| Propaquizafop + | 500 + 750 | 94.3 | 91.9 | 89.1 | 76.5 | 72.5 | 69.4 | 1.23 | 1.27 | 1.28 |
| Fomesafen | | | | | | | | | | |
| Propaquizafop + | 400 + 1000 | 96.4 | 92.3 | 91.9 | 75.6 | 72.4 | 70 | 1.27 | 1.27 | 1.31 |
| Fomesafen | | | | | | | | | | |

### Example 3: Effect of Tank Mix of Fomesafen+Propaquizafop on Eleusine indica

TABLE 3
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 64 | 56.7 | 53.4 | | | | | | |
| Propaquizafop | 500 | 65.5 | 57.7 | 55.2 | | | | | | |
| Fomesafen | 500 | 8.2 | 4.7 | 3.3 | | | | | | |
| Fomesafen | 750 | 12.6 | 6.3 | 5 | | | | | | |
| Fomesafen | 1000 | 17.1 | 8.9 | 7.5 | | | | | | |
| Propaquizafop + | 400 + 500 | 88.6 | 83.5 | 81.9 | 66.9 | 58.7 | 54.9 | 1.32 | 1.42 | 1.49 |
| Fomesafen | | | | | | | | | | |
| Propaquizafop + | 500 + 500 | 89.7 | 83.1 | 82.7 | 68.3 | 59.7 | 56.7 | 1.31 | 1.39 | 1.46 |
| Fomesafen | | | | | | | | | | |
| Propaquizafop + | 400 + 750 | 91.2 | 85.3 | 84.7 | 68.5 | 59.4 | 55.7 | 1.33 | 1.44 | 1.52 |
| Fomesafen | | | | | | | | | | |
| Propaquizafop + | 500 + 750 | 92 | 86.3 | 85.9 | 69.9 | 60.4 | 57.4 | 1.32 | 1.43 | 1.5 |
| Fomesafen | | | | | | | | | | |
| Propaquizafop + | 400 + 1000 | 93.6 | 88 | 86.4 | 70.1 | 60.5 | 56.9 | 1.34 | 1.45 | 1.52 |
| Fomesafen | | | | | | | | | | |
| Propaquizafop + | 500 + 1000 | 97.7 | 92.7 | 91 | 71.4 | 61.5 | 58.6 | 1.37 | 1.51 | 1.55 |
| Fomesafen | | | | | | | | | | |

### Example 4: Effect of Tank Mix of Fomesafen+Propaquizafop on Digera arvensis

TABLE 4
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 13.9 | 9.3 | 2.1 | | | | | | |
| Propaquizafop | 500 | 19.5 | 15.5 | 14.4 | | | | | | |
| Fomesafen | 500 | 70 | 68.5 | 66.6 | | | | | | |
| Fomesafen | 750 | 74.2 | 71.5 | 70.5 | | | | | | |
| Fomesafen | 1000 | 78.2 | 75.2 | 74 | | | | | | |
| Propaquizafop + | 400 + 500 | 92.2 | 89.4 | 88.7 | 74.2 | 71.5 | 67.3 | 1.24 | 1.25 | 1.32 |
| Fomesafen | | | | | | | | | | |
| Propaquizafop + | 500 + 500 | 93.3 | 90 | 89.6 | 75.8 | 73.4 | 71.4 | 1.23 | 1.23 | 1.26 |
| Fomesafen | | | | | | | | | | |
| Propaquizafop + | 400 + 750 | 95.1 | 93 | 91.1 | 77.8 | 74.1 | 71.1 | 1.22 | 1.25 | 1.28 |
| Fomesafen | | | | | | | | | | |
| Propaquizafop + | 500 + 750 | 96.6 | 93.6 | 92.9 | 79.3 | 75.9 | 74.7 | 1.22 | 1.23 | 1.24 |
| Fomesafen | | | | | | | | | | |
| Propaquizafop + | 400 + 1000 | 98 | 94.4 | 93.8 | 81.2 | 77.5 | 74.5 | 1.21 | 1.22 | 1.26 |
| Fomesafen | | | | | | | | | | |
| Propaquizafop + | 500 + 1000 | 99 | 95.5 | 94.1 | 82.4 | 79 | 77.7 | 1.2 | 1.21 | 1.21 |
| Fomesafen | | | | | | | | | | |

### Example 5: Effect of Tank Mix of Fomesafen+Propaquizafop on Commelina benghalensis

TABLE 5
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 6.8 | 3.2 | 2 | | | | | | |
| Propaquizafop | 500 | 16.6 | 10.5 | 7.7 | | | | | | |
| Fomesafen | 500 | 66.2 | 64.2 | 62.7 | | | | | | |
| Fomesafen | 750 | 72.8 | 70.2 | 69.7 | | | | | | |
| Fomesafen | 1000 | 77.8 | 75 | 72.5 | | | | | | |
| Propaquizafop + | 400 + 500 | 92.2 | 89.2 | 87.6 | 68.6 | 65.3 | 63.4 | 1.35 | 1.37 | 1.38 |
| Fomesafen | | | | | | | | | | |
| Propaquizafop + | 500 + 500 | 93 | 90.1 | 88.3 | 71.8 | 68 | 65.5 | 1.29 | 1.33 | 1.35 |
| Fomesafen | | | | | | | | | | |
| Propaquizafop + | 400 + 750 | 94.2 | 90.1 | 89.7 | 74.6 | 71.2 | 70.3 | 1.26 | 1.27 | 1.27 |
| Fomesafen | | | | | | | | | | |
| Propaquizafop + | 500 + 750 | 95.8 | 93.1 | 92 | 77.3 | 73.4 | 72.1 | 1.24 | 1.27 | 1.28 |
| Fomesafen | | | | | | | | | | |
| Propaquizafop + | 400 + 1000 | 97.3 | 95.3 | 94 | 79.4 | 75.8 | 73.1 | 1.23 | 1.26 | 1.29 |
| Fomesafen | | | | | | | | | | |
| Propaquizafop + | 500 + 1000 | 98.2 | 96.1 | 94.5 | 81.5 | 77.6 | 74.6 | 1.2 | 1.24 | 1.27 |
| Fomesafen | | | | | | | | | | |

### Example 6: Effect of Tank Mix of Fomesafen+Propaquizafop on Acalypha indica

TABLE 6
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 7.1 | 3.7 | 2.9 | | | | | | |
| Propaquizafop | 500 | 25.2 | 12.3 | 9.8 | | | | | | |
| Fomesafen | 500 | 58.2 | 55.4 | 53.8 | | | | | | |
| Fomesafen | 750 | 63.8 | 61.7 | 60.6 | | | | | | |
| Fomesafen | 1000 | 75.9 | 73.6 | 72.6 | | | | | | |
| Propaquizafop + | 400 + 500 | 93.6 | 91.5 | 90.9 | 61.2 | 57 | 55.2 | 1.53 | 1.61 | 1.65 |
| Fomesafen | | | | | | | | | | |
| Propaquizafop + | 500 + 500 | 94.3 | 92.1 | 91.4 | 68.7 | 60.9 | 58.4 | 1.37 | 1.51 | 1.57 |
| Fomesafen | | | | | | | | | | |
| Propaquizafop + | 400 + 750 | 96.7 | 94.6 | 93.8 | 66.3 | 63.1 | 61.8 | 1.46 | 1.5 | 1.52 |
| Fomesafen | | | | | | | | | | |
| Propaquizafop + | 500 + 750 | 97.6 | 95.2 | 94.1 | 72.9 | 66.4 | 64.5 | 1.34 | 1.43 | 1.46 |
| Fomesafen | | | | | | | | | | |
| Propaquizafop + | 400 + 1000 | 98.6 | 96.3 | 95.6 | 77.6 | 74.6 | 73.4 | 1.27 | 1.29 | 1.3 |
| Fomesafen | | | | | | | | | | |
| Propaquizafop + | 500 + 1000 | 99.4 | 97 | 95.7 | 82 | 76.9 | 75.3 | 1.21 | 1.26 | 1.27 |
| Fomesafen | | | | | | | | | | |

### Example 7: Effect of Tank Mix of Fomesafen+Propaquizafop on Amaranthus viridis

TABLE 7
Tank mix of Propaquizafop + Fomesafen on Soybean

| | Application | | | | | | | | | |
|---|---|---|---|---|---|---|---|---|---|---|
| | rate | % control observed | | | % control expected | | | Colby Ratio o/e | | |
| AI | (ml/Acre) | 15DAA | 30DAA | 45DAA | 15DAA | 30DAA | 45DAA | 15DAA | 30DAA | 45DAA |
| Propaquizafop | 400 | 8.2 | 2.6 | 2.3 | | | | | | |
| Propaquizafop | 500 | 13.6 | 7.6 | 7.1 | | | | | | |
| Fomesafen | 500 | 67.7 | 66.9 | 64.8 | | | | | | |
| Fomesafen | 750 | 71.3 | 70.5 | 69.1 | | | | | | |
| Fomesafen | 1000 | 74.7 | 73.7 | 71.1 | | | | | | |
| Propaquizafop + | 400 + 500 | 91.4 | 88.5 | 87.3 | 70.4 | 67.7 | 65.6 | 1.3 | 1.31 | 1.33 |
| Fomesafen | | | | | | | | | | |
| Propaquizafop + | 500 + 500 | 92.2 | 89.4 | 88 | 72.1 | 69.4 | 67.3 | 1.28 | 1.29 | 1.31 |
| Fomesafen | | | | | | | | | | |
| Propaquizafop + | 400 + 750 | 93.9 | 90.8 | 89.4 | 73.7 | 71.3 | 69.8 | 1.27 | 1.27 | 1.28 |
| Fomesafen | | | | | | | | | | |
| Propaquizafop + | 500 + 750 | 94.9 | 92.7 | 91.8 | 75.2 | 72.7 | 71.3 | 1.26 | 1.27 | 1.29 |
| Fomesafen | | | | | | | | | | |
| Propaquizafop + | 400 + 1000 | 95.9 | 94.1 | 93.4 | 76.8 | 74.4 | 71.8 | 1.25 | 1.26 | 1.3 |
| Fomesafen | | | | | | | | | | |
| Propaquizafop + | 500 + 1000 | 96.4 | 95.2 | 94.3 | 78.1 | 75.7 | 73.2 | 1.23 | 1.26 | 1.29 |
| Fomesafen | | | | | | | | | | |

As shown in Tables 1-7 the percentage of herbicidal control observed for the combination is greater than the expected percentage (Colby Ratio o/e), thereby showing synergism for the mixture of fomesafen and propaquizafop over a broad range of applications rates of each active ingredient. The above data shows efficacy as well as synergism of the combination of fomesafen and propaquizafop on Echinochloa colona, Dinebra arabica, Eleusine indica, Digera arvensis, Commelina benghalensis, Acalypha indica and Amaranthus viridis in a crop of soybean. It can therefore, be concluded that by combining fomesafen and propaquizafop, a herbicidal mixture which has a broader spectrum of activity is obtained without crop damage. Although only a small number of weeds are shown in the above Tables, it can be appreciated that similar efficacy results may be obtained when the mixture or herbicides of the above mentioned formulation are applied to different grasses and broad-leaved weeds.

It is thus apparent that there is provided, in accordance with the present disclosure, a herbicidal mixture. Many alternatives, modifications, and variations are enabled by the present disclosure. While specific embodiments have been shown and described in detail to illustrate the application of the principles of the subject matter, it will be understood that it may be embodied otherwise without departing from such principles. Features of the disclosed embodiments may be combined, rearranged, omitted, etc., within the scope of the subject matter to produce additional embodiments. Furthermore, certain features may sometimes be used to advantage without a corresponding use of other features. Accordingly, it is intended to embrace all such alternatives, modifications, and variations that fall within the spirit and broad scope of the appended claims.

The description and embodiments should not to be taken as limiting the scope of the appended claims. Rather, it should be understood that not every disclosed feature is necessary in every implementation of the subject matter. It should also be understood that throughout this disclosure, where a process or method is shown or described, the steps of the method may be performed in any order or simultaneously, unless it is clear from the context that one step depends on another being performed first. As used throughout this application, the word “may” is used in a permissive sense (i.e., meaning “having the potential to”), rather than the mandatory sense (i.e., meaning “must”).

All publications, patents and patent applications mentioned in this specification are herein incorporated in their entirety by reference into the specification, to the same extent as if each individual publication, patent or patent application was specifically and individually indicated to be incorporated herein by reference.

It is thus apparent that there is provided in accordance with the present disclosure, mixtures, compositions and methods of a herbicidal mixture. Many alternatives, modifications, and variations are enabled by the present disclosure. While specific embodiments have been shown and described in detail to illustrate the application of the principles of the present subject matter, it will be understood that the subject matter may be embodied otherwise without departing from such principles. Accordingly, Applicants intend to embrace all such alternatives, modifications, equivalents, and variations that are within the spirit and scope of the present subject matter.

1. A synergistic herbicidal mixture comprising fomesafen and propaquizafop.

2. (canceled)

3. The herbicidal mixture of claim 1, wherein the weight ratio of fomesafen to propaquizafop is from 1:10 to 10:1.

4. The herbicidal mixture of claim 3, wherein the weight ratio of fomesafen to propaquizafop is from 1:5 to about 5:1.

5. The herbicidal mixture of claim 1, wherein fomesafen and propaquizafop are applied jointly or in a succession.

6. The herbicidal mixture of claim 1, wherein the mixture is applied in an amount of from 1-500 g/ha.

7. The herbicidal mixture of claim 6, wherein the mixture is applied in an amount of from 1-100 g/ha.

8. A synergistic herbicidal composition for the selective control of weeds and grasses in crops of cultivated plants comprising a fomesafen and propaquizafop, optionally at least one agriculturally acceptable carrier, and optionally comprising at least one surfactant, solid diluent, liquid diluent, or a combination thereof.

9-11. (canceled)

12. The composition of claim 8, wherein the weight ratio of fomesafen to propaquizafop is from 1:10 to 10:1.

13. The composition of claim 12, wherein the weight ratio of fomesafen to propaquizafop is from 1:5 to about 5:1.

14. The composition of claim 8, wherein fomesafen and propaquizafop are applied jointly or in a succession.

15. The composition of claim 8, wherein the composition is applied in an amount of from 1-500 g/ha.

16. The composition of claim 15, wherein the composition is applied in an amount of from 1-100 g/ha.

17. A method of controlling undesired vegetation comprising applying to a locus of the undesired vegetation a synergistically effective amount of a herbicidal combination of fomesafen and propaquizafop.

18. (canceled)

19. The method of claim 17, wherein the weight ratio of fomesafen to propaquizafop is from 1:10 to 10:1.

20. The method of claim 19, wherein the weight ratio of fomesafen to propaquizafop is from 1:5 to about 5:1.

21. The method of claim 17, wherein the mixture is applied in an amount of from 1-500 g/ha.

22. The method of claim 21, wherein the mixture is applied in an amount of from 1-100 g/ha.

23. The method of claim 17, wherein fomesafen and propaquizafop are applied jointly or in a succession.

24. The method of claim 17, wherein the mixture is applied pre-emergence, post-emergence or pre- and post-emergence to the locus of the undesired vegetation or the area under cultivation.

25. The method of claim 17, wherein the undesired vegetation is selected from the group comprising monocotyledonous weeds and dicotyledonous weeds.
